(19) United States
(12) Patent Application Publication
(10) Pub. No.: US 2012/0105498 A1
(43) Pub. Date: May 3, 2012

(54) LUMINESCENCE DRIVING APPARATUS, DISPLAY APPARATUS AND DRIVING METHOD THEREOF

(75) Inventors: Tae-sung KIM, Suwon-si (KR); Young-deok CHOI, Seoul (KR); Jeong-il KANG, Yongin-si (KR)

(73) Assignee: SAMSUNG ELECTRONICS CO., LTD., Suwon-si (KR)

(21) Appl. No.: 13/244,319

(22) Filed: Sep. 24, 2011

(30) Foreign Application Priority Data
Oct. 27, 2010 (KR) 10-2010-0105367

(51) Int. Cl. G09G 5/10; H05B 37/02

(52) U.S. Cl. 345/690; 315/294

(57) ABSTRACT

A switching-type luminescence driving apparatus, a display apparatus, and a driving method thereof are provided. The luminescence driving apparatus includes: a plurality of driving circuits which are connected to a plurality of LEDs having a common anode terminal and which drive the plurality of LEDs according to control pulse modulation; and a controller which controls voltages of a plurality of cathode terminals of the plurality of LEDs so as to independently control each voltage of the plurality of LEDs.

### CROSS-REFERENCE TO RELATED APPLICATION

This application claims priority under 35 U.S.C. §119 from Korean Patent Application No. 10-2010-0105367, filed on Oct. 27, 2010 in the Korean Intellectual Property Office, the disclosure of which is incorporated herein by reference in its entirety.

### BACKGROUND

1. Field

Apparatuses and methods consistent with exemplary embodiments relate to a luminescence driving apparatus, a display apparatus, and a driving method thereof, and more particularly, to a luminescence driving apparatus applied to a backlight unit of a display apparatus, a display apparatus, and a driving method thereof.

2. Description of the Related Art

Active development of Light Guide Plate (LGP) Edge-lit Light Emitting Diode (LED) Backlight Units (BLUs) reflects the recent trend to minimize display apparatuses.

In a related art, a display apparatus having a local dimming operation includes an LED module 10 containing a plurality of LED array blocks as shown in FIG. 1A, wherein the LED module 10 is driven by a switching-type driving circuit as shown in FIG. 1B.

The related art switching-type LED driving circuits as shown in FIG. 1B use LED modules in which a plurality of anodes and cathodes of the LED array blocks are separated from each other (see FIG. 1A). However, this related art structure requires more wires to connect the LED driving circuits and the LED modules, thereby raising the material expenses.

In addition, the number of patterns required for the LED modules is increased, and thus the width of the LED modules is to be enlarged such that the minimization of the display apparatus is limited.

### SUMMARY

One or more exemplary embodiments address at least the above problems and/or disadvantages and other disadvantages not described above. Also, an exemplary embodiment is not required to overcome the disadvantages described above, and an exemplary embodiment may not overcome any of the problems described above.

Aspects of exemplary embodiments relate to a luminescence driving apparatus that drives a plurality of light emitting diodes (LEDs), a display apparatus, and a driving method thereof.

According to an aspect of an exemplary embodiment, there is provided a switching-type luminescence driving apparatus, the apparatus including: a plurality of driving circuits which connect to a plurality of LEDs having a common anode terminal and which drives the plurality of LEDs according to control pulse modulation; and a controller which controls voltages of a plurality of cathode terminals of the plurality of LEDs so as to independently control each voltage of the plurality of LEDs.

A driving circuit, from among the plurality of driving circuits, may include: an input terminal connected to the common anode terminal and receiving a driving source; a capacitor connected to a cathode terminal of an LED corresponding to the driving circuit, from among the plurality of LEDs; and a converter connected in parallel to both ends of the capacitor.

The controller may control a voltage of the capacitor to control a voltage of the LED by using a voltage difference between the driving source and the capacitor.

The controller may include: a first resistor connected to an end of the capacitor; a current amplifier connected to the first resistor; a comparator connected to the current amplifier; and a first transistor switch into which control pulse modulation is input by the comparator.

The converter may be activated by a coupled inductor having a primary winding wire and a secondary winding wire and may convert a current flowing in the primary winding wire into a current flowing in the secondary winding wire.

The driving circuit may further include a second transistor switch connected between the LED and the capacitor.

The voltage of the LED may be determined according to:

V_{f}=V_{dc}+V_{c}=V_{dc}+D/(1−D)*V_{dc}=V_{dc}/(1−D)

wherein V_{f} denotes the voltage of the LED, V_{dc} denotes the driving source, V_{c} denotes the cathode terminal voltage of the LED, and D denotes a duty ratio.

The plurality of LEDs may be a plurality of LED arrays.

The control pulse modulation may be a Pulse Width Modulation (PWM) dimming signal.

According to an aspect of another exemplary embodiment, there is provided a display apparatus, including: a display panel; a plurality of LED arrays providing light to the display panel and having a common anode terminal; and a plurality of luminescence driving units that connects to and drives the plurality of LED arrays according to control pulse modulation, and controls voltages of a plurality of cathode terminals of the plurality of LED arrays so as to independently control voltages of the plurality of LED arrays.

A luminescence driving unit, from among the plurality of luminescence driving units, may include: an input terminal which connects to the common anode terminal and receives a driving source; a capacitor connected to a cathode terminal of an LED array corresponding to the luminescence driving unit, from among the plurality of LED arrays; a coupled inductor including a primary winding wire and a secondary winding wire that are connected in parallel to both ends of the capacitor; and a controller which controls a voltage of the capacitor to control a voltage of the LED array by using a voltage difference between the driving source and the capacitor.

According to an aspect of another exemplary embodiment, there is provided a driving method of a switching-type luminescence driving apparatus, the method including: driving a plurality of LEDs according to control pulse modulation via a plurality of driving circuits connected to the plurality of LEDs having a common anode terminal; and controlling voltages of the plurality of LEDs by adjusting cathode terminal voltages of the plurality of LEDs.

A driving circuit, from among the plurality of driving circuits, may include: an input terminal connected to the common anode terminal and receiving a driving source; a capacitor connected to a cathode terminal of an LED corresponding to the driving circuit, from among the plurality of LEDs; and a converter connected in parallel to both ends of the capacitor.

The independent controlling may include controlling a voltage of the capacitor to control a voltage of the LED by using a voltage difference between the driving source and the capacitor.

The driving circuit may further include: a first resistor connected to an end of the capacitor; a current amplifier connected to the first resistor; a comparator connected to the current amplifier; and a first transistor switch into which the control pulse modulation is input by the comparator.

The converter may be a coupled inductor having a primary winding wire and a secondary winding wire and may convert a current flowing in the primary winding wire into a current flowing in the secondary winding wire.

The first transistor switch may be turned on or off according to the control pulse modulation and may control the current flowing in the primary winding wire.

The driving circuit may further include a second transistor switch connected between the LED and the capacitor.

The voltage of the LED may be determined according to:

V_{f}=V_{dc}+V_{c}=V_{dc}+D/(1−D)*V_{dc}=V_{dc}/(1−D)

wherein V_{f} denotes the voltage of the LED, V_{dc} denotes the driving source, V_{c} denotes the cathode terminal voltage of the LED, and D denotes a duty ratio.

The plurality of LEDs may be a plurality of LED arrays.

The control pulse modulation may be a PWM dimming signal.

According to an aspect of another exemplary embodiment, there is provided a driving circuit which drives a plurality of LEDs having a common anode terminal according to control pulse modulation, the driving circuit including: an input terminal which connects to the common anode terminal and receives a driving source; a first capacitor which connects to a cathode terminal of a first LED, from among the plurality of LEDs; and a second capacitor which connects to a cathode terminal of a second LED, from among the plurality of LEDs, wherein a voltage of the first capacitor controls a voltage of the first LED according to a voltage difference between the driving source and the first capacitor, and a voltage of the second capacitor controls a voltage of the second LED according to a voltage difference between the driving source and the second capacitor.

As a result, according to aspects of exemplary embodiments, a plurality of LED array blocks in LED modules is provided with common anodes, thereby enabling to reduce the number of wires and the number of patterns of the LED modules, and to minimize the width of the LED module, accordingly.

Furthermore, the plurality of LED array blocks having the common anodes may be driven by a switching-type LED driving circuits.

### BRIEF DESCRIPTION OF THE DRAWINGS

The above and/or other aspects will be more apparent by describing certain exemplary embodiments with reference to the accompanying drawings, in which:

FIGS. 1A and 1B are depicted to describe the drawbacks of a related art light emitting diode (LED) module;

FIG. 2 shows a structure of a luminescence apparatus according to an exemplary embodiment;

FIG. 3 is a block-diagram showing a structure of a luminescence driving apparatus according to an exemplary embodiment;

FIG. 4 is a block-diagram showing a structure of a display apparatus according to an exemplary embodiment;

FIGS. 5A and 5B show a structure of an LED module according to an exemplary embodiment;

FIGS. 6A and 6B are circuit diagrams showing circuit configurations of a luminescence driving apparatus according to one or more exemplary embodiments;

FIGS. 7A and 7B are circuit diagrams showing driving circuits using a coupled inductor having a pulse width modulation (PWM) dimming switch according to one or more other exemplary embodiments; and

FIG. 8 is a flowchart depicting a driving method of a luminescence driving apparatus according to an exemplary embodiment.

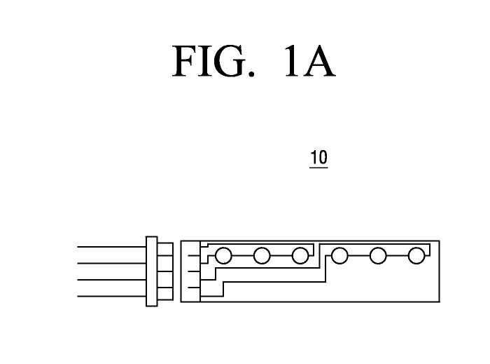

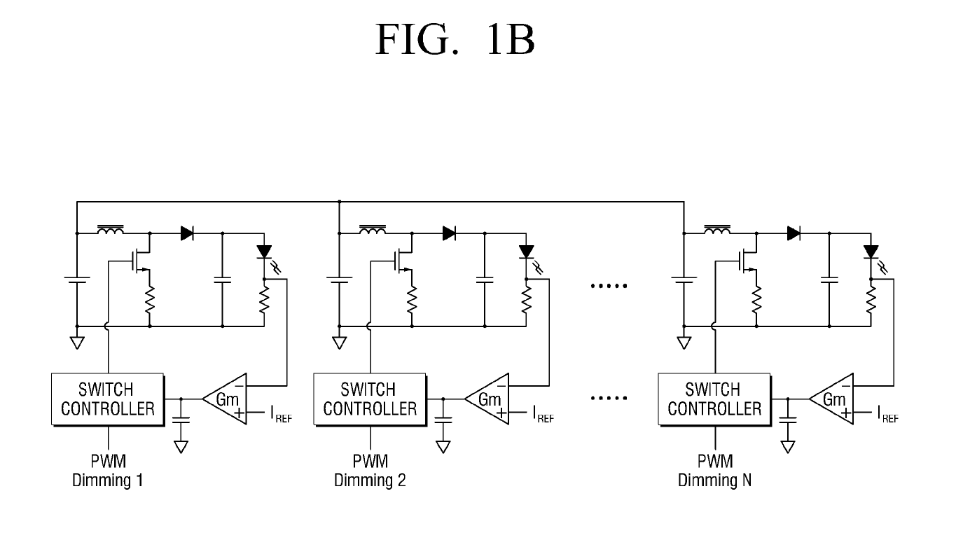

### DETAILED DESCRIPTION OF EXEMPLARY EMBODIMENTS

Certain exemplary embodiments will now be described in greater detail with reference to the accompanying drawings.

In the following description, the same drawing reference numerals are used for the same elements even in different drawings. The matters defined in the description, such as detailed constructions and elements, are provided to assist in a comprehensive understanding of exemplary embodiments. Thus, it is apparent that an exemplary embodiment can be carried out without those specifically defined matters. Also, well-known functions or constructions are not described in detail since they would obscure the description with unnecessary detail. Hereinafter, expressions such as “at least one of,” when preceding a list of elements, modify the entire list of elements and do not modify the individual elements of the list.

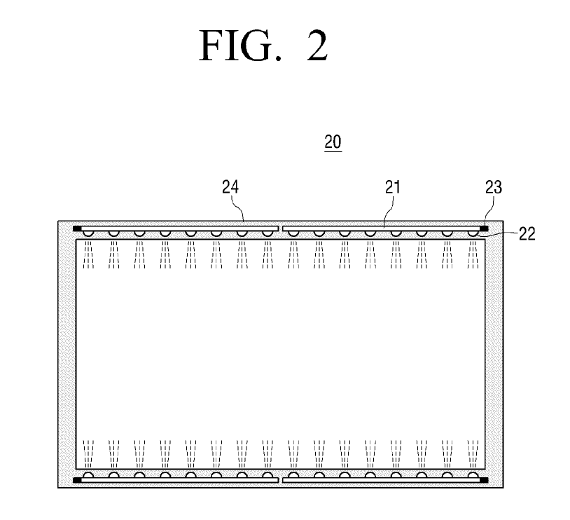

FIG. 2 shows a structure of a luminescence apparatus 20 according to an exemplary embodiment.

The luminescence apparatus 20 may be a Light Guide Plate (LGP) Edge-lit Light Emitting Diode (LED) Backlight Unit (BLU).

The LGP Edge-lit LED BLU is installed at one or more sides of the LGP with a bar-type LED module in compliance with the degree of the light or the size of the display.

As shown in FIG. 2, a plurality of bar-type LED modules may be installed at one or more sides of the LGP. The LED modules may be installed at the top and bottom sides of the LGP as illustrated in FIG. 2, though it is understood that another exemplary embodiment is not limited thereto. For example, according to another exemplary embodiment, the LED modules may be installed at the right and left sides of the LGP or may be installed at at least one of the top, bottom, right and left sides of the LGP. Furthermore, according to other exemplary embodiments, only one LED module may be provided, only one side of the LGP may have one or more LED modules installed thereon, and only a portion one or more sides of the LGP may have one or more LED module installed thereon.

Instead of a plurality of LED modules at the top side of the LGP illustrated in FIG. 2, only one LED module may be installed at the top side thereof. Otherwise, a plurality of LED modules may be installed according to the increment of the size of the display apparatus. This may also be applied to the LED modules at the bottom side of the LGP.

The LGP may be in a hexahedron planar structure and maintain a constant brightness and color uniformity in a liquid crystal panel by equally dispersing the light emitted from at least one LED module and induce incident light straight towards the liquid crystal panel.

The LGP Edge-lit LED BLU 20 may include an LED bar 21, an LED 22, a wire connecting part 23, and a bottom chassis 24.

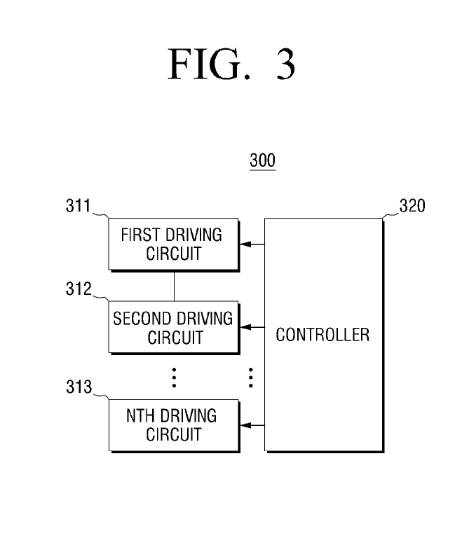

FIG. 3 is a block-diagram showing a structure of a luminescence driving apparatus 300 according to an exemplary embodiment.

As shown in FIG. 3, the luminescence driving apparatus 300 includes a plurality of driving circuits 311, 312 and 313, and a controller 320.

The luminescence driving apparatus 300 drives a plurality of LEDs (not shown) in a switching manner and may be, but is not limited hereto, a boost-type Integrated Circuit (IC).

The LEDs (not shown) may be included in an LED module having LED array blocks at the edge of a BLU as illustrated in FIG. 2.

The luminescence driving apparatus 300 may be applied to the driving circuits of the Edge-lit LED BLU. The Edge-lit LED BLU emits light towards the center of the panel by providing the LED arrays only at one or more lateral sides of the frame.

The plurality of driving circuits 311, 312 and 313 connects, respectively, to the plurality of LEDs (not shown) and drives the LEDs according to control pulse modulation. The control pulse modulation may be a pulse width modulation (PWM) dimming signal.

The plurality of driving circuits 311, 312 and 313 connects, respectively, to a plurality of LEDs having a common anode terminal and may drive the plurality of LEDs (not shown) in accordance with the control pulse modulation.

The plurality of driving circuits 311, 312 and 313 connects, respectively, to the common anode terminal and may include an input terminal receiving a driving source (i.e., a driving source voltage), a capacitor connected to each cathode terminal of the plurality of LEDs, and a converter connected in parallel to both ends of the capacitor. The converter is a coupled inductor including a primary winding wire and a secondary winding wire and may convert the current flowing in the primary winding wire into the current flowing in the secondary winding wire.

The controller 320 adjusts the voltage of the capacitor to control voltages of the plurality of LEDs by using the voltage difference of the capacitor and the driving source transmitted through the input terminal. The controller 320 performs the controlling operation according to control pulse modulation and may be, for example, a PWM controller (or a switching controller) providing a switching signal to control the PWM according to the PWM dimming signal.

The controller 320 adjusts the cathode terminal voltage of the plurality of LEDs (not shown) so as to control the plurality of the LEDs (not shown).

The controller 320 may include a first resistor connected to an end of the capacitor, a current amplifier connected to the first resistor, a comparator connected to the current amplifier, and a first transistor switch where the control pulse modulation is inputted via the comparator. The first transistor switch may be turned on or off according to the control pulse modulation (e.g., PWM dimming signal).

The first transistor switch is turned on or off in compliance with control pulse modulation to control the current flowing in the primary winding wire of the coupled inductor.

Each of the driving circuits 311, 312 and 313 may further include a second transistor switch connected between the LED and the capacitor and/or between the capacitor and the first resistor.

The output voltage of the LED may be determined by the below formula 1:

V_{f}=V_{dc}+V_{c}=V_{dc}+D/(1−D)*V_{dc}=V_{dc}/(1−D) [FORMULA 1]

wherein V_{f} denotes the output voltage of the LED, V_{dc} denotes the driving source, V_{dc} denotes the cathode terminal voltage of the LED, and D denotes the duty ratio.

Each of the driving circuits 311, 312 and 313 may further include a filter connected between an end of the first resistor and the current amplifier.

The controller 320 is an individual component from the plurality of driving circuits 311, 312 and 313 in an exemplary embodiment. However, the controller 320 may be a predetermined circuit installed in the plurality of driving circuits 311, 312 and 313. This will be described in detail below.

Furthermore, the luminescence driving apparatus 300 may further include a protective unit (not shown).

The protective unit (not shown) may protect at least one LED when one or more LEDs (not shown) and the driving circuits 311, 312 and 313 are determined to be shut down.

The protective unit (not shown) performs the protective operation by preventing the driving source from being transmitted to the input terminals of the driving circuits 311, 312 and 313.

The protective unit (not shown) may prevent over voltage. Specifically, Over Voltage Protection (OVP) may shut down the output when the voltage reaches a certain level and may be performed by, for example, turning off the switch through which the power is transmitted and is connected to the LED.

The protective unit (not shown) may be further applied to Over Current Protection (OCP), Over Load Protection (OLP), Over Temperature Protection (OTP), Short Circuit Protection (SCP), and so on.

The controller 320 and the protective unit (not shown) are individual components from the driving circuits 311, 312 and 313 in an exemplary embodiment. However, the controller 320 and the protective unit (not shown) may be installed in the plurality of driving circuits 311, 312 and 313 according to another exemplary embodiment.

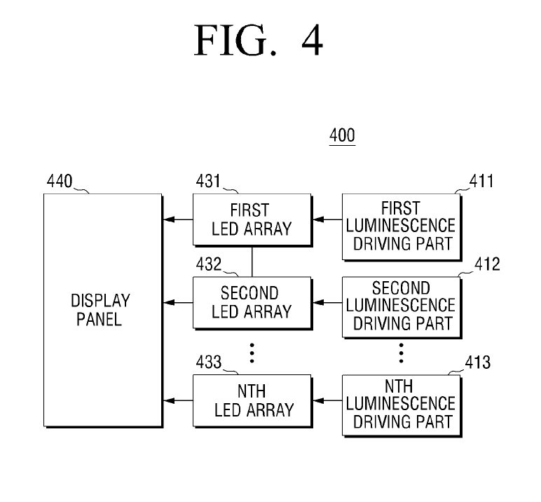

FIG. 4 is a block-diagram showing a structure of a display apparatus 400 according to an exemplary embodiment.

As shown in FIG. 4, the display apparatus 400 includes a plurality of luminescence driving units 411, 412 and 413, a controller 420, a plurality of LED arrays 431, 432 and 433, and a display panel 440.

The display apparatus 400 may be a three-dimensional (3D) image display apparatus including an Edge-lit LED BLU, e.g., a 3D liquid crystal display (LCD) TV.

The LCD TV may not emit light itself and may therefore include an LED BLU to emit backlight into the LCD panel. Accordingly, the plurality of luminescence driving units 411, 412 and 413 and the plurality of LED array blocks 431, 432 and 433 may be used by an LED BLU. The plurality of luminescence driving units 411, 412 and 413 may be implemented in a switching manner.

The display panel 440 may be an LCD panel. The LCD panel adjusts light transmittance of the LED BLU, and visualizes and displays the image signal on the screen.

The plurality of LED array blocks 431, 432 and 433 provides the light to the display panel 440 and may have the common anode terminal.

The plurality of luminescence driving units 411, 412 and 413 is connected to the plurality of LED array blocks 431, 432 and 433 and drives the plurality of LED array blocks 431, 432 and 433 according to control pulse modulation.

The controller 420 adjusts voltages of the cathode terminals corresponding to the plurality of LED array blocks and controls the plurality of LED array blocks 431, 432 and 433.

The plurality of LED array blocks 431, 432 and 433 connects to the common anode terminal and includes an input terminal receiving a driving source, a capacitor connected to a cathode terminal of a corresponding LED array, a coupled inductor having a primary winding wire and a secondary winding wire connected in parallel to both ends of the capacitor, and a controller adjusting a voltage of the capacitor to control voltages of the LED arrays by using the voltage difference of the driving source and the capacitor. The controller may perform the controlling operation according to control pulse modulation and may be, for example, a PWM controller (or a switching controller) providing a switching signal to control PWM according to the PWM dimming signal.

The display apparatus 400 may include an image input unit (not shown) and an image processing unit (not shown).

The image input units (not shown) includes one or more input terminals. For example, at least one of a component image signal, a Super-Video Home System (S-VHS) image signal, a composite image signal, a High Definition Multimedia Interface (HDMI) signal, etc., is inputted through the one or more input terminals from an external apparatus such as a video player or a DVD player, and an audio signal corresponding to the above image signal is inputted to the image input unit.

The image processing unit (not shown) performs a signal processing for at least one of video-decoding, video scaling, Frame Rate Conversion (FRC), etc., of the broadcasting contents or the image signals inputted from the image input part. The image processing unit generates an image signal by converting the inputted image to be appropriately displayed on the LCD panel (not shown) and generates a control signal for the brightness of the BLU.

The luminescence driving apparatus 300 may further include a voltage sensor (not shown) to prevent the over voltage.

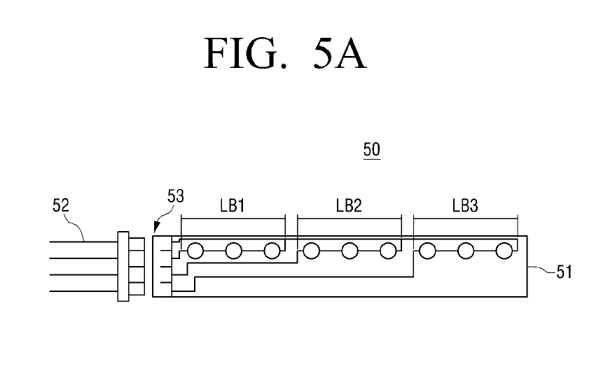

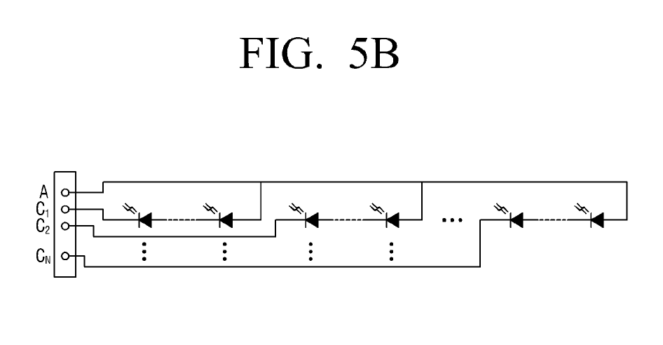

FIGS. 5A and 5B show a structure of an LED module 50 according to an exemplary embodiment.

As shown in FIG. 5A, the LED module 50 according to an exemplary embodiment includes a plurality of LED array blocks (LB1, LB2, and LB3), an LED bar 51, a wire 52, and a wire connecting part 53. The configuration of FIG. 5A may be applied in FIG. 5B.

As shown in FIG. 5B, the plurality of LED array blocks (LB₁, LB₂, . . . , LB_{N}) may include cathode terminals (C₁, . . . , C_{N}) to respectively correspond to the common anode terminal (A) and the LED array blocks (LB₁, LB₂, . . . , LB_{N}).

The common anode terminal (A) commonly used in the plurality of LED array blocks (LB1, LB2, and LBN) may be connected to the input terminals receiving the driving source. This will be described in detail below.

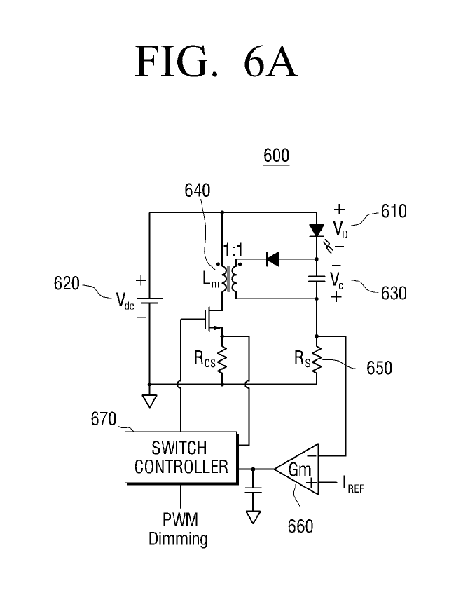

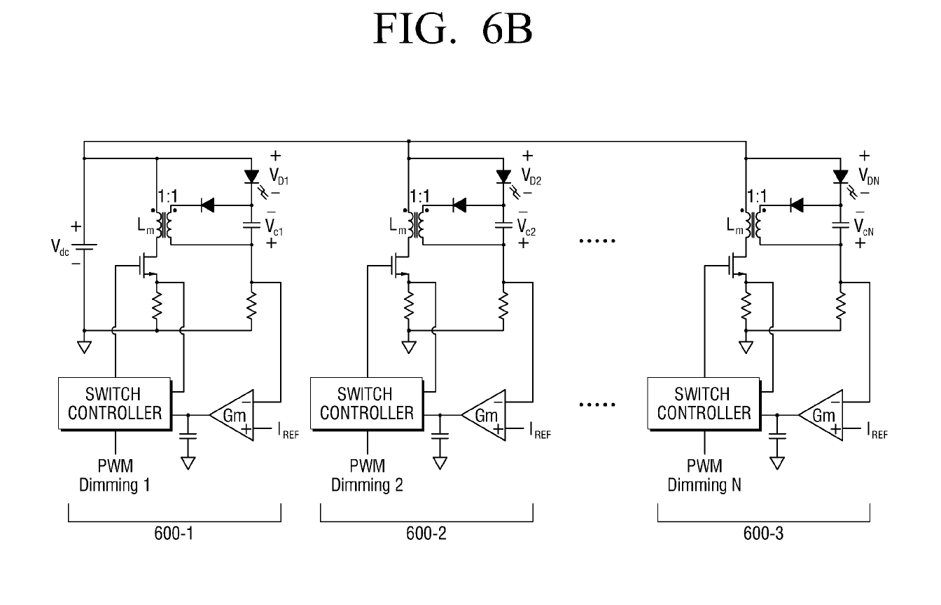

FIGS. 6A and 6B are circuit diagrams showing circuit configurations of a luminescence driving apparatus 600 according to one or more exemplary embodiments.

The luminescence driving apparatus 600 in FIGS. 6A and 6B is used to drive an LGP Edge-lit LED BLU, though it is understood that another exemplary embodiment is not limited thereto.

The LGP Edge-lit LED BLU may be at one or more sides of the LGP with bar-type LED modules (LB1, LB2, and LB3 in FIG. 5A) according to, for example, at least one of a predetermined amount of desired light and the size of a screen. The LED module in the panel is connected through a harness (e.g. the wire 52 in FIG. 5A) to the LED driving circuit located at the outer part of the panel and is controlled to allow a constant current corresponding to a predetermined brightness to flow in each LED bar (51 in FIG. 5A). The current flowing in the LED bar (51 in FIG. 5A) is detected by a sensing resistor (Rs) 650 and is controlled to be a constant current identical to a current command level (I_{REF}).

The luminescence driving apparatus 600 is connected to one or more LEDs 610 through a connector (not shown) and drives the one or more LEDs 610. In particular, the luminescence driving apparatus 600 drives the one or more LEDs 610 according to control pulse modulation, for example, a PWM dimming signal (PWM_Dim).

FIG. 6A shows a driving circuit 620 included in a luminescence driving apparatus 600 according to an exemplary embodiment.

As shown in FIG. 6A, the driving circuit 620 may include an input terminal 620 (V_{dc}), which receives a driving source and is connected at an end thereof to the ground, a capacitor 630 connected to one or more LEDs 610, a coupled inductor 640 connected in parallel to the capacitor 630, a first resistor 650 (Rₛ) connected to an end of the capacitor 630, a current amplifier 660 connected to another end of the first resistor 650 (Rₛ), and a switching controller 670 connected to the current amplifier 660. The switching controller 670 may be a comparator or a circuit.

The driving circuit 620 may further include a filter (not shown) connected between the first resistor 650 (Rₛ) and the current amplifier 660. The filter (not shown) prevents any malfunction due to noise and so on. Furthermore, a counter (not shown) may be provided in the driving circuit.

In FIG. 6A, the anode terminal voltage of the LED array block is an input voltage V_{dc}, and the cathode terminal voltage of the LED array block is −V_{c}. Thus, the substantial voltage applied to both ends of the LED block is set as V_{dc}+V_{c}(=V_{f}). The cathode terminal voltage of the LED array block, V_{c}, is adjusted to modify the voltage (V_{f}) applied to both ends of the LED array block so as to allow the predetermined current to flow in the LED array block. As shown in FIG. 6B, a common anode may be used to correspond to the plurality of LED array blocks of an LED module.

If the first and second turn ratios of the coupled inductor 640 is set to be 1:1, V_{c} may be obtained by using the formula V_{c}=D/(1−D)*V_{dc} and the LED output voltage, V_{f}, may be applied in the aforementioned Formula 1, V_{f}=V_{dc}+V_{c}=V_{dc}/(1−D). Thus, the output feature becomes identical to that of the boost-type of FIG. 6A. The first and second turn ratios of the coupled inductor 640 may be 1:1, but it is not limited hereto, and may be randomly set.

FIG. 6B is a circuit-diagram illustrating a configuration of a luminescence driving apparatus 600-1, 600-2, 600-3 to individually drive a plurality of LED arrays by using the driving circuit of FIG. 6A.

As illustrated in FIG. 6B, the luminescence driving apparatus 600-1, 600-2, and 600-3 of FIG. 6B may be embodied by connecting a plurality of driving circuits of FIG. 6A.

The common anode terminal (A) of FIG. 5B is connected to the input terminal (V_{dc}), and each of the cathode terminals (C1, C2, . . . , CN) is connected to the cathode terminals (V_{c}1, V_{c}2, V_{c}3) of the driving circuits 600-1, 600-2, and 600-3. Thus, the plurality of LED array blocks may be operated via a switching-type LED driving circuit that drives an LED module having the plurality of LED arrays therein with a common anode used to minimize the number of connecting wires and the patterns of the LED modules.

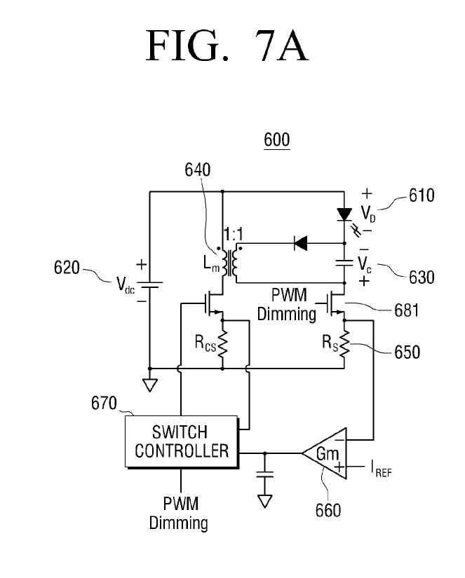

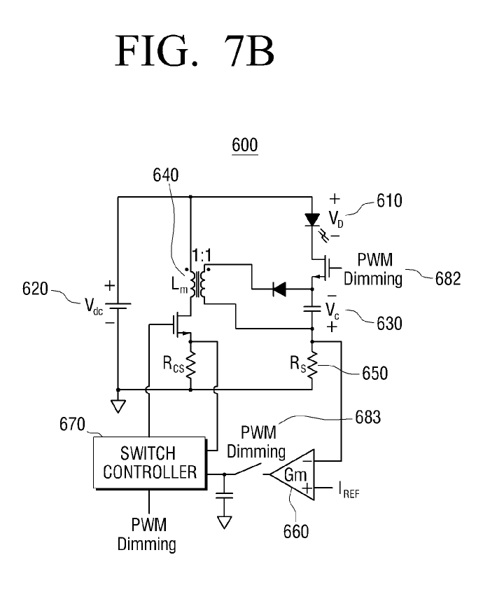

FIGS. 7A and 7B are block diagrams showing driving circuits using a coupled inductor having a PWM dimming switch according to one or more other exemplary embodiments.

As shown in FIG. 7A, a capacitor 630 is connected at an end thereof to an LED array 610, and the capacitor 630 is connected at another end thereof to a PWM dimming switch 681. However, it is understood that another exemplary embodiment is not limited thereto.

For example, according to another exemplary embodiment, the PWM dimming switch 681 may be between at least one of the LED array 610 and the capacitor 630 and the current amplifier 660 and the switching controller 670, as shown in FIG. 7B.

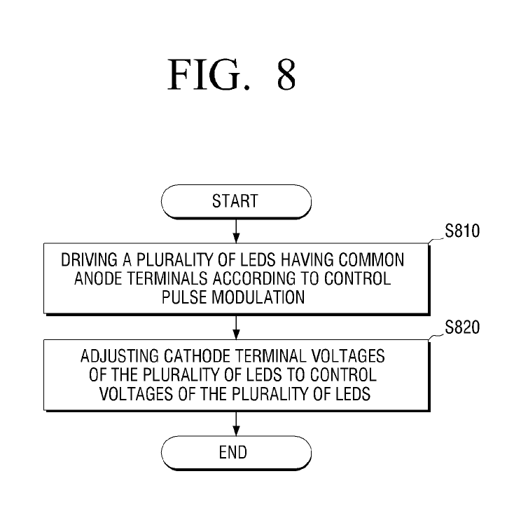

FIG. 8 is a flowchart depicting a driving method of a luminescence driving apparatus according to an exemplary embodiment.

A driving method of a switching-type luminescence driving apparatus as illustrated in FIG. 8 includes driving a plurality of LEDs according to control pulse modulation by using a plurality of driving circuits respectively connected to the plurality of LEDs having a common anode terminal (operation S810), where the plurality of LEDs may be a plurality of LED arrays.

The plurality of LEDs is controlled by adjusting the cathode terminal voltages of the plurality of driving circuits (operation S820).

The plurality of driving circuits may include an input terminal connected to the common anode terminal and receiving a driving source, a capacitor connected to the cathode terminal of the LED, and a converter connected in parallel to both ends of the capacitor.

In the controlling step (operation S820), the voltage of the capacitor is adjusted to control the voltage of the LED by using the voltage difference of the driving source and the capacitor.

The plurality of driving circuits may further include a first resistor connected to an end of the capacitor, a current amplifier connected to the first resistor, a comparator connected to the current amplifier, and a first transistor switch into which control pulse modulation is inputted via the comparator.

The converter is a coupled inductor including a primary winding wire and a secondary winding wire and may convert the current flowing in the primary winding wire into the current flowing in the secondary winding wire.

The first transistor switch is turned on or off according to control pulse modulation and controls the current flowing in the primary winding wire.

The plurality of driving circuits may further include a second transistor switch connected between the LED and the capacitor.

Exemplary embodiments may further include a computer readable recording medium including a program for controlling a luminescence driving apparatus or a driving method of a display apparatus. The computer readable recording medium includes all types of recording apparatuses stored with readable data for computer systems. Examples of the computer readable recording medium are ROM, RAM, CD-ROM, magnetic tapes, floppy disks, optical data stored apparatuses and so on. The computer readable recording medium is distributed to the computer network systems so that the codes readable in the computer distribution system are stored.

As apparent from the foregoing, there is an advantage according to aspects of exemplary embodiments in that a plurality of LED array blocks in the LED module is provided with a common anode, thereby enabling to reduce the number of wires and the patterns of the LED modules, and to minimize the width of the LED modules, accordingly.

Furthermore, the plurality of LED array blocks having the common anode is driven by the switching-type LED driving circuits.

The foregoing exemplary embodiments and advantages are merely exemplary and are not to be construed as limiting the present inventive concept. The present teaching can be readily applied to other types of apparatuses. Also, the description of exemplary embodiments is intended to be illustrative, and not to limit the scope of the claims, and many alternatives, modifications, and variations will be apparent to those skilled in the art.

What is claimed is:

1. A switching-type luminescence driving apparatus, comprising:
a plurality of driving circuits which are connected to a plurality of light emitting diodes (LEDs) having a common anode terminal, and which drive the plurality of LEDs according to control pulse modulation; and
a controller which controls voltages of a plurality of cathode terminals of the plurality of LEDs so as to independently control each voltage of the plurality of LEDs.

2. The apparatus as claimed in claim 1, wherein:
a driving circuit, from among the plurality of driving circuits, comprises:
an input terminal which connects to the common anode terminal and receives a driving source,
a capacitor which connects to a cathode terminal of an LED corresponding to the driving circuit, from among the plurality of LEDs, and
a converter which connects in parallel to both ends of the capacitor; and
the controller controls a voltage of the capacitor to control a voltage of the LED by using a voltage difference between the driving source and the capacitor.

3. The apparatus as claimed in claim 2, wherein the controller comprises:
a first resistor which is connected to an end of the capacitor;
a current amplifier which is connected to the first resistor;
a comparator which is connected to the current amplifier; and
a first transistor switch into which the control pulse modulation is input by the comparator.

4. The apparatus as claimed in claim 3, wherein the converter is activated by a coupled inductor having a primary winding wire and a secondary winding wire and converts a current flowing in the primary winding wire into a current flowing in the secondary winding wire.

5. The apparatus as claimed in claim 2, wherein the driving circuit further comprises a second transistor switch connected between the LED and the capacitor.

6. The apparatus as claimed in claim 2, wherein the voltage of the LED is determined according to:
V_{f}=V_{dc}+V_{c}=V_{dc}+D/(1−D)*V_{dc}=V_{dc}/(1−D)
wherein V_{f} denotes the voltage of the LED, V_{dc} denotes the driving source, V_{c} denotes a cathode terminal voltage of the LED, and D denotes a duty ratio.

7. The apparatus as claimed in claim 1, wherein the plurality of LEDs is a plurality of LED arrays.

8. The apparatus as claimed in claim 1, wherein the control pulse modulation is a Pulse Width Modulation (PWM) dimming signal.

9. A display apparatus comprising:
a display panel;
a plurality of LED arrays which provides light to the display panel and having a common anode terminal;
a plurality of luminescence driving units which connects to and drives the plurality of LED arrays according to control pulse modulation, and controls voltages of a plurality of cathode terminals of the plurality of LED arrays so as to independently control respective voltages of the plurality of LED arrays.

10. The apparatus as claimed in claim 9, wherein a luminescence driving unit, from among the plurality of luminescence driving units, comprises:
an input terminal which connects to the common anode terminal and receives a driving source;
a capacitor which is connected to a cathode terminal of an LED array corresponding to the luminescence driving unit, from among the plurality of LED arrays;
a coupled inductor which comprises a primary winding wire and a secondary winding wire that are connected in parallel to both ends of the capacitor; and
a controller which controls a voltage of the capacitor to control a voltage of the LED array by using a voltage difference between the driving source and the capacitor.

11. The apparatus as claimed in claim 9, wherein the plurality of LED arrays is activated in a switching manner.

12. A driving method of a switching-type luminescence driving apparatus comprising:
driving a plurality of LEDs according to control pulse modulation via a plurality of driving circuits connected to the plurality of LEDs having a common anode terminal; and
independently controlling respective voltages of the plurality of LEDs by controlling voltages of a plurality of cathode terminals of the plurality of LEDs.

13. The method as claimed in claim 12, wherein:
a driving circuit, from among the plurality of driving circuits, comprises:
an input terminal connected to the common anode terminal and receiving a driving source,
a capacitor connected to a cathode terminal of an LED, corresponding to the driving circuit, from among the plurality of LEDs, and
a converter connected in parallel to both ends of the capacitor; and
the independently controlling comprises controlling a voltage of the capacitor is adjusted to control a voltage of the LED by using a voltage difference between the driving source and the capacitor.

14. The method as claimed in claim 13, wherein the driving circuit further comprises:
a first resistor connected to an end of the capacitor;
a current amplifier connected to the first resistor;
a comparator connected to the current amplifier; and
a first transistor switch into which the control pulse modulation is input by the comparator.

15. The method as claimed in claim 14, wherein the converter is a coupled inductor having a primary winding wire and a secondary winding wire and converts a current flowing in the primary winding wire into a current flowing in the secondary winding wire, and the first transistor switch is turned on or off according to the control pulse modulation and controls the current flowing in the primary winding wire.

16. The method as claimed in claim 13, wherein the driving circuit further comprises a second transistor switch connected between the LED and the capacitor.

17. The method as claimed in claim 13, wherein the voltage of the LED is determined according to:
V_{f}=V_{dc}+V_{c}=V_{dc}+D/(1−D)*V_{dc}=V_{dc}/(1−D)
wherein V_{f} denotes the voltage of the LED, V_{dc} denotes the driving source, V_{c} denotes a cathode terminal voltage of the LED, and D denotes a duty ratio.

18. The method as claimed in claim 12, wherein the plurality of LEDs is a plurality of LED arrays.

19. The method as claimed in claim 12, wherein the control pulse modulation is a PWM dimming signal.

20. A driving circuit which drives a plurality of LEDs having a common anode terminal according to control pulse modulation, the driving circuit comprising:
an input terminal which connects to the common anode terminal and receives a driving source;
a first capacitor which connects to a cathode terminal of a first LED, from among the plurality of LEDs; and
a second capacitor which connects to a cathode terminal of a second LED, from among the plurality of LEDs,
wherein a voltage of the first capacitor controls a voltage of the first LED according to a voltage difference between the driving source and the first capacitor, and a voltage of the second capacitor controls a voltage of the second LED according to a voltage difference between the driving source and the second capacitor.
